(19) United States
(12) Patent Application Publication
(10) Pub. No.: US 2015/0153558 A1
(43) Pub. Date: Jun. 4, 2015

(54) WIDE-FIELD MICROSCOPY USING SELF-ASSEMBLED LIQUID LENSES

(71) Applicant: THE REGENTS OF THE UNIVERSITY OF CALIFORNIA, Oakland, CA (US)

(72) Inventors: Aydogan Ozcan, Los Angeles, CA (US); Onur Mudanyali, Los Angeles, CA (US); Euan McLeod, Alhambra, CA (US)

(21) Appl. No.: 14/406,199

(22) PCT Filed: Jun. 5, 2013
(86) PCT No.: PCT/US2013/044366

§ 371 Date: Dec. 5, 2014

Related U.S. Application Data
(60) Provisional application No. 61/656,944, filed on Jun. 7, 2012.

(51) Int. Cl. G02B 21/36; G02B 21/00; G02B 21/14

(52) U.S. Cl. CPC G02B 21/367; G02B 21/14; G02B 21/0004

(57) ABSTRACT

A method of imaging a sample includes depositing a droplet containing the sample on a substrate, the sample having a plurality of particles contained within a fluid. The substrate is then tilted to gravitationally drive the droplet to an edge of the substrate while forming a dispersed monolayer of particles having liquid lenses surrounding the particles. A plurality of lower resolution images of the particles contained on the substrate are obtained, wherein the substrate is interposed between an illumination source and an image sensor, wherein each lower resolution image is obtained at discrete spatial locations. The plurality of lower resolution images of the particles are converted into a higher resolution image. At least one of an amplitude image and a phase image of the particles contained within the sample is then reconstructed. In some embodiments, only a single lower resolution image may be sufficient.

### RELATED APPLICATION

This application claims priority to U.S. Provisional Patent Application No. 61/656,944 filed on Jun. 7, 2012, which is hereby incorporated by reference in its entirety Priority is claimed pursuant to 35 U.S.C. §119.

### STATEMENT REGARDING FEDERALLY SPONSORED RESEARCH OR DEVELOPMENT

This invention was made with Government support under Grant No. 1DP2 OD006427-01, awarded by the National Institutes of Health; Grant No. CBET-0954482 awarded by the National Science Foundation; Grant No. N00014-12-1-0307 awarded by the United States Navy, Office of Naval Research, and Grant No. W911NF-11-1-0303 awarded by the Army Research Office. The Government has certain rights in this invention.

### FIELD OF THE INVENTION

The field of the invention generally relates to imaging systems and methods and more particularly imaging systems that have particular application in the imaging and analysis of small particles such as cells, organelles, cellular particles, viruses, and the like.

### BACKGROUND

Digital holography has been experiencing a rapid growth over the last several years, together with the availability of cheaper and better digital components as well as more robust and faster reconstruction algorithms, to provide new microscopy modalities that improve various aspects of conventional optical microscopes. In an effort to achieve wide-field on-chip microscopy, the use of unit fringe magnification (F˜1) in lens-free in-line digital holography to claim an FOV of ˜24 mm² with a spatial resolution of <2 μm and an NA of ˜0.1-0.2 has been demonstrated. See Oh C. et al., On-chip differential interference contrast microscopy using lens-less digital holography, Opt Express.; 18(5):4717-4726 (2010) and Isikman et al., Lens-free Cell Holography On a Chip: From Holographic Cell Signatures to Microscopic Reconstruction, Proceedings of IEEE Photonics Society Annual Fall Meeting, pp. 404-405 (2009), both of which are incorporated herein by reference. This recent work used a spatially incoherent light source that is filtered by an unusually large aperture (˜50-100 μm diameter); and unlike most other lens-less in-line holography approaches, the sample plane was placed much closer to the detector chip rather than the aperture plane, i.e., z₁>>z₂. This unique hologram recording geometry enables the entire active area of the sensor to act as the imaging FOV of the holographic microscope since F˜1.

More recently, a lens-free super-resolution holographic microscope has been proposed which achieves sub-micron spatial resolution over a large field-of-view of e.g., ˜24 mm² See Bishara et al., “Holographic pixel super-resolution in portable lensless on-chip microscopy using a fiber-optic array,” Lab Chip 11, 1276 (2011), which is incorporated herein by reference. The microscope works based on partially-coherent lens-free digital in-line holography using multiple light sources (e.g., light-emitting diodes—LEDs) placed at ˜3-6 cm away from the sample plane such that at a given time only a single source illuminates the objects, projecting in-line holograms of the specimens onto a CMOS sensor-chip. Because the objects are placed very close to the sensor chip (e.g., ˜1-2 mm) the entire active area of the sensor becomes the imaging field-of-view, and the fringe-magnification is unit. As a result of this, these holographic diffraction signatures are unfortunately under-sampled due to the limited pixel size at the CMOS chip (e.g., ˜2-3 μm). To mitigate this pixel size limitation on spatial resolution, several lens-free holograms of the same static scene are recorded as different LEDs are turned on and off, which creates sub-pixel shifted holograms of the specimens. By using pixel super-resolution techniques, these sub-pixel shifted under-sampled holograms can be digitally put together to synthesize an effective pixel size of e.g., ˜300-400 nm, which can now resolve/sample much larger portion of the higher spatial frequency oscillations within the lens-free object hologram. Unfortunately, the imaging performance of this lens-free microscopy tool is still limited by the detection SNR, which may pose certain limitations for imaging of e.g., weakly scattering phase objects that are refractive index matched to their surrounding medium such as sub-micron bacteria in water.

One approach to imaging small particles using lens-free holographic methods such as those disclosed above include the use of smaller pixel seizes at the sampling (i.e., detector plane). However, such a sampling related bandwidth increase only translates into better resolution if the detection SNR is maintained or improved as the pixel size of the imager chip is reduced. Therefore, the optical design of the pixel architecture (especially in CMOS imager technology) is extremely important to maintain the external quantum efficiency of each pixel over a large angular range. While reduced pixel sizes (e.g. <1 μm) and higher external quantum efficiencies can further improve the resolution of lens-free on-chip microscopy to, e.g., the sub-200 nm range in the future, other sample-preparation approaches have been attempted to improve SNR.

Wetting thin-film dynamics have been studied in chemistry and biology and attempts have been made to incorporate the same in imaging modalities. Among these prior results, a recent application of thin wetting films towards on-chip detection of bacteria provides an approach where the formation of evaporation-based wetting films was used to enhance e.g., diffraction signatures of bacteria on a chip. See e.g., C. P. Allier et al., Thin wetting film lensless imaging, Proc. SPIE 7906, 760608 (2011). PCT Publication No. WO/2013/019640 discloses a holographic microscopic method that uses wetting films to image objects. In that method a droplet is mechanically vibrated to create a thin wetting film that improves imaging performance Still further improvements are needed to image small, nano-scale particles such as viruses and the like and in particular objects smaller than 100 nm.

### SUMMARY

In one embodiment, a method of imaging a sample includes depositing a droplet containing the sample on a substrate, the sample having a plurality of particles contained within a fluid. The substrate is then tilted to gravitationally drive the droplet to an edge of the substrate while forming a dispersed monolayer of particles having liquid lenses surrounding said particles. At least one lower resolution image of the particles contained on the substrate is obtained, wherein the substrate is interposed between an illumination source and an image sensor. Optionally, a plurality of lower resolution images are obtained, wherein each lower resolution image is obtained at discrete spatial locations. The plurality of lower resolution images of the particles are converted into a higher resolution image. If a single lower resolution image is sufficient, this last operation of converting to a higher resolution image is not necessary. At least one of an amplitude image and a phase image of the particles contained within the sample is then reconstructed.

In another embodiment, a method of imaging a sample contained on a substrate includes forming a dispersed monolayer of particles having liquid lenses surrounding said particles on the substrate. The substrate is interposed between an illumination source and an imaging system which, in some embodiments, may be an image sensor. The particles disposed on the substrate are illuminated with the illumination source. Images of the particles are obtained with the imaging system. The liquid lenses surrounding the particles on the substrate are formed by first depositing a droplet of the sample onto the substrate and tilting the substrate. The droplet is gravitationally driven to the edge of the substrate to leave liquid lenses surrounding the particles.

### BRIEF DESCRIPTION OF THE DRAWINGS

FIG. 1A schematically illustrates a system for imaging an object within a sample.

FIG. 1B illustrates a sample holder containing a sample (and objects) thereon.

FIG. 1C illustrates a system for imaging an object according to one embodiment that uses two-dimensional aperture shifting.

FIG. 2A illustrates a side view of a sample holder containing a dispersed monolayer of particles having liquid lenses surrounding the objects.

FIG. 2B illustrates a top view of the sample holder of FIG. 2A.

FIGS. 2C-2E illustrate different self-assembled liquid nano-lens (e.g., meniscus) shapes for different substrate (θₛ) and particle (θₚ) contact angles.

FIG. 2F illustrates an SEM image of a bead with residue of a desiccated nano-lens.

FIG. 2G illustrates an SEM image of a bead without any residue of a desiccated nano-lens.

FIGS. 3A-3E illustrate an illustrative method of forming a dispersed monolayer of particles having liquid lenses surrounding the objects on a substrate.

FIG. 4A illustrates a substrate having a dispersed monolayer of particles having liquid lenses surrounding the objects flipped over and facing an image sensor.

FIG. 4B illustrates a top-level flowchart of how the system obtains higher resolution pixel Super Resolution (Pixel SR) images of objects within a sample and reconstructs at least one of an amplitude image and a phase image.

FIG. 5A illustrates a full field-of-view of a CMOS chip with an expanded region.

FIG. 5B illustrates an expanded view of the square region of FIG. 5A.

FIG. 5C illustrates the raw lens-free Bayer-pattern RGB image.

FIG. 5D illustrates the high-resolution monochrome hologram obtained using pixel super-resolution.

FIG. 5E illustrates the holographic reconstruction from FIG. 5D which shows the detection of single nano-particles.

FIG. 5F illustrates the SEM image of the rectangular region of FIG. 5E.

FIG. 6A illustrates an image obtained of 95 nm sized particles using a bright-field, oil-immersion 100× objective-lens (NA=1.25).

FIG. 6B illustrates the lens-free amplitude reconstruction image of the same field of view of FIG. 6A obtained using pixel super-resolved images synthesized with 64 sub-pixel shifted holographic frames.

FIG. 6C illustrates the lens-free amplitude reconstruction image of the same field of view of FIG. 6A obtained using pixel super-resolved images synthesized with 36 sub-pixel shifted holographic frames.

FIG. 6D illustrates the lens-free amplitude reconstruction image of the same field of view of FIG. 6A obtained using pixel super-resolved images synthesized with 16 sub-pixel shifted holographic frames.

FIG. 6E illustrates the lens-free amplitude reconstruction image of the same field of view of FIG. 6A obtained using pixel super-resolved images synthesized with 8 sub-pixel shifted holographic frames.

FIG. 6F illustrates the lens-free amplitude reconstruction image of the same field of view of FIG. 6A obtained using pixel super-resolved images synthesized with 4 sub-pixel shifted holographic frames.

FIG. 6G illustrates the lens-free amplitude reconstruction image of the same field of view of FIG. 6A obtained using pixel super-resolved image from 1 sub-pixel shifted holographic frame.

FIG. 7A illustrates a 100× oil-immersions objective lens image (NA=1.25) of 198 nm beads. The sample was prepared without self-assembled lenses.

FIG. 7B illustrates the lens-free phase reconstruction image of the field of view of FIG. 7A. The sample was prepared without self-assembled lenses.

FIG. 7C illustrates the lens-free amplitude reconstruction image of the field of view of FIG. 7A. The sample was prepared without self-assembled lenses.

FIG. 7D illustrates the lens-free super-resolved holographic image of the field of view of FIG. 7A. The sample was prepared without self-assembled lenses.

FIG. 7E illustrates a 100× oil-immersions objective lens image (NA=1.25) of 198 nm beads. The sample was prepared with self-assembled lenses.

FIG. 7F illustrates the lens-free phase reconstruction image of the field of view of FIG. 7E. The sample was prepared with self-assembled lenses.

FIG. 7G illustrates the lens-free amplitude reconstruction image of the field of view of FIG. 7E. The sample was prepared with self-assembled lenses.

FIG. 7H illustrates the lens-free super-resolved holographic image of the field of view of FIG. 7E. The sample was prepared with self-assembled lenses.

FIG. 8A illustrates a 100× oil-immersions objective lens image (NA=1.25) of 95 nm beads. The sample was prepared without self-assembled lenses.

FIG. 8B illustrates the lens-free phase reconstruction image of the field of view of FIG. 8A. The sample was prepared without self-assembled lenses.

FIG. 8C illustrates the lens-free amplitude reconstruction image of the field of view of FIG. 8A. The sample was prepared without self-assembled lenses.

FIG. 8D illustrates the lens-free super-resolved holographic image of the field of view of FIG. 8A. The sample was prepared without self-assembled lenses.

FIG. 8E illustrates a 100× oil-immersions objective lens image (NA=1.25) of 95 nm beads. The sample was prepared with self-assembled lenses.

FIG. 8F illustrates the lens-free phase reconstruction image of the field of view of FIG. 8E. The sample was prepared with self-assembled lenses.

FIG. 8G illustrates the lens-free amplitude reconstruction image of the field of view of FIG. 8E. The sample was prepared with self-assembled lenses.

FIG. 8H illustrates the lens-free super-resolved holographic image of the field of view of FIG. 8E. The sample was prepared with self-assembled lenses.

FIG. 9A illustrates the lens-free super-resolved holographic images of H1N1 virus particles.

FIG. 9B illustrates the lens-free amplitude reconstruction of the super-resolved image.

FIG. 9C illustrates the lens-free phase reconstruction of the super-resolved image.

FIG. 9D illustrates the bright-filed oil immersion image of the same field of view (100× oil objective, NA=1.25).

FIG. 9E illustrates the lens-free super-resolved holographic images of H1N1 virus particles.

FIG. 9F illustrates the lens-free amplitude reconstruction of the super-resolved image.

FIG. 9G illustrates the lens-free phase reconstruction of the super-resolved image.

FIG. 9H illustrates the bright-filed oil immersion image of the same field of view (100× oil objective, NA=1.25).

FIG. 9I illustrates the lens-free super-resolved holographic images of H1N1 virus particles.

FIG. 9J illustrates the lens-free amplitude reconstruction of the super-resolved image.

FIG. 9K illustrates the lens-free phase reconstruction of the super-resolved image.

FIG. 9L illustrates the bright-filed oil immersion image of the same field of view (100× oil objective, NA=1.25).

FIG. 9M illustrates the lens-free super-resolved holographic images of adenovirus particles.

FIG. 9N illustrates the lens-free amplitude reconstruction of the super-resolved image.

FIG. 9O illustrates the lens-free phase reconstruction of the super-resolved image.

FIG. 9P illustrates a Scanning Electron Microscope (SEM) image of the corresponding field of view of FIG. 9M.

FIG. 9Q illustrates a SEM image of a single H1N1 virus particle surrounded by a liquid desiccated by the SEM sample preparation process.

FIG. 9R illustrates a normal-incidence SEM image of a single adenovirus particle.

FIG. 10A illustrates the results of a FDTD simulated digital holographic reconstruction of 95 nm particles.

FIG. 10B illustrates the results of the thin-lens model used in the simulated digital holographic reconstruction of 95 nm particles.

FIG. 11A illustrates the raw holographic image with a magnified cropped region A taken from the raw image.

FIG. 11B illustrates cropped region B which was taken from the cropped region A of FIG. 11A.

FIG. 11C illustrates the super-resolved holographic image of cropped region B.

FIG. 11D illustrates the reconstructed amplitude image of the super-resolved holographic image.

FIG. 11E illustrates the reconstructed phase image of the super-resolved holographic image.

FIG. 11F illustrates a contrast and background-subtracted 60× objective lens-based image of the corresponding region-of-interest.

FIG. 11G illustrates a corresponding SEM image of region S1 of FIG. 11F.

FIG. 11H illustrates a corresponding SEM image of region S2 of FIG. 11F.

### DETAILED DESCRIPTION OF THE ILLUSTRATED EMBODIMENTS

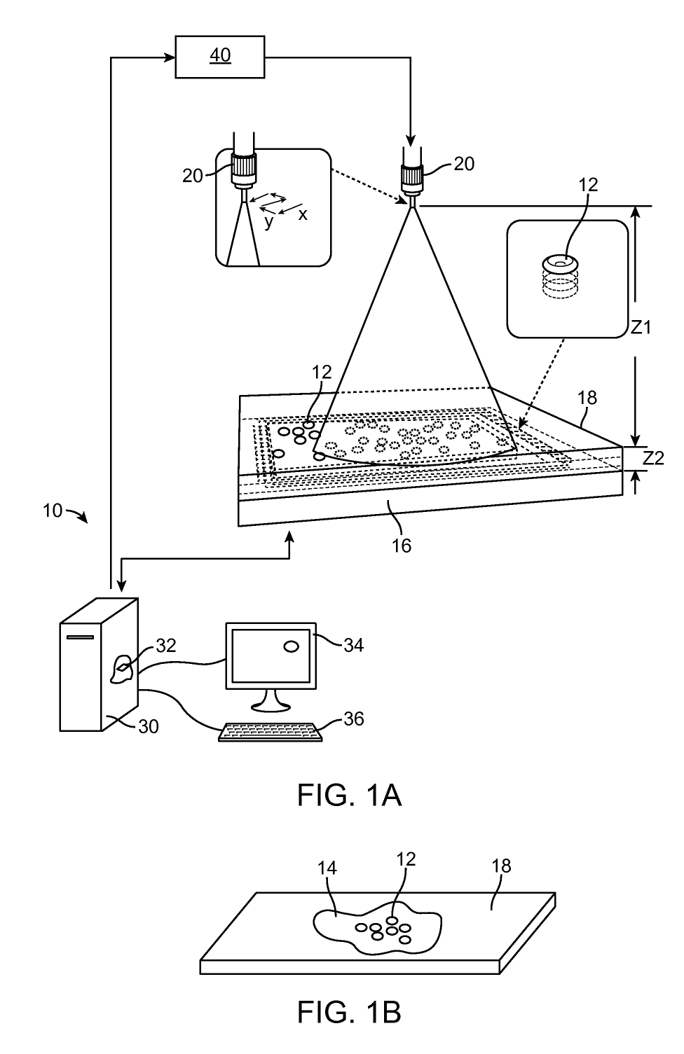

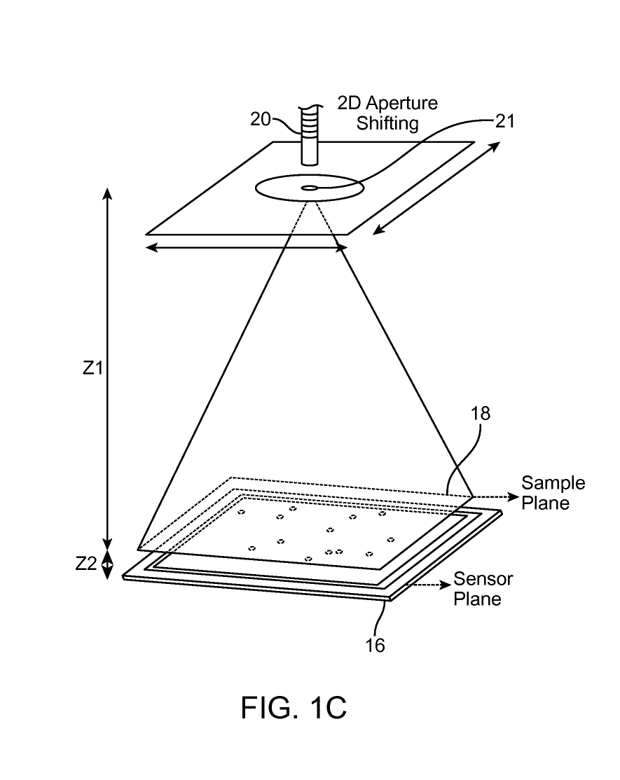

FIG. 1A illustrates a system 10 for imaging of an object 12 or multiple objects 12 within a sample 14 (best seen in FIG. 1B). The object 12 may include a cell, virus, or biological component or constituent (e.g., a cellular organelle or substructure). The object 12 may even include a multicellular organism or the like. For example, the object 12 may be a blood cell (e.g., red blood cell (RBC), white blood cell), bacteria, or protozoa. In another aspect, the object 12 may be a particularly small biological object such as a virus, prion, or the like. Alternatively, the object 12 may be a particle or other object. Generally, particles or objects having a size within the range of about 0.05 μm to about 500 μm may be imaged with the system 10, however the use of self-assembled lenses surrounding individual objects 12 is particularly suited for objects 12 smaller than about 100 nm (e.g., objects having their longest dimension less than about 100 nm).

FIG. 1A illustrates objects 12 in the form of biological particles (e.g., cells or viruses) to be imaged that are disposed some distance z₂ above an image sensor 16. As explained herein, this distance z₂ is adjustable as illustrated by the Δz in the inset of FIG. 1A. The sample 14 containing one or more objects 12 is typically placed on a optically transparent substrate 18 such as a glass or plastic slide, coverslip, or the like as seen in FIG. 1B. As explained herein in more detail, the optically transparent substrate 18 may include a hydrophilic substrate 18. For example, the optically transparent substrate 18 may include glass that is treated to make the surface containing the sample hydrophilic.

The surface of image sensor 16 may be in contact with or close proximity to the sample holder 18. Generally, the objects 12 within the sample 14 are located within several millimeters within the active surface of the image sensor 16. The image sensor 16 may include, for example, a charged coupled device (CCD) or a complementary metal-oxide semiconductor (CMOS) device. The image sensor 16 may be monochromatic or color. The image sensor 16 generally has a small pixel size which is less than 9.0 μm in size and more particularly, smaller than 5.0 μm in size (e.g., 2.2 μm or smaller). Generally, image sensors 16 having smaller pixel size will produce higher resolutions. As explained herein, sub-pixel resolution can be obtained by using the method of capturing and processing multiple lower-resolution holograms, that are spatially shifted with respect to each other by sub-pixel pitch distances.

Still referring to FIG. 1A, the system 10 includes an illumination source 20 that is configured to illuminate a first side (top side as seen in FIG. 1A) of the sample holder 18. The illumination source 20 is preferably a spatially coherent or a partially coherent light source but may also include an incoherent light source. Light emitting diodes (LEDs) are one example of an illumination source 20. LEDs are relative inexpensive, durable, and have generally low power requirements. Of course, other light sources may also be used such as a Xenon lamp with a filter. A light bulb is also an option as the illumination source 20. A coherent beam of light such as a laser may also be used (e.g., laser diode). The illumination source 20 preferably has a spectral bandwidth that is between about 0.1 and about 100 nm, although the spectral bandwidth may be even smaller or larger. Further, the illumination source 20 may include at least partially coherent light having a spatial coherence diameter between about 0.1 to 10,000 μm.

The illumination source 20 may be coupled to an optical fiber as seen in FIG. 1A or another optical waveguide. If the illumination source 20 is a lamp or light bulb, it may be used in connection with an aperture 21 as seen in FIG. 1C that is subject to two-dimensional shifting or multiple apertures in the case of an array which acts as a spatial filter that is interposed between the illumination source 20 and the sample. The term optical waveguide as used herein refers to optical fibers, fiber-optic cables, integrated chip-scale waveguides, an array of apertures and the like. With respect to the optical fiber, the fiber includes an inner core with a higher refractive index than the outer surface so that light is guided therein. The optical fiber itself operates as a spatial filter. In this embodiment, the core of the optical fiber may have a diameter within the range of about 50 μm to about 100 μm. As seen in FIG. 1A, the distal end of the fiber optic cable illumination source 20 is located at a distance z₁ from the sample holder 18. The imaging plane of the image sensor 16 is located at a distance z₂ from the sample holder 18. In the system 10 described herein, z₂<<z₁. For example, the distance z₁ may be on the order of around 1 cm to around 10 cm. In other embodiments, the range may be smaller, for example, between around 5 cm to around 10 cm. The distance z₂ may be on the order of around 0.05 mm to 2 cm, however, in other embodiments this distance z₂ may be between around 1 mm to 2 mm. Of course, as described herein, the z₂ distance is adjustable in increments ranging from about 1 μm to about 1.0 cm although a larger range such as between 0.1 μm to about 10.0 cm is also contemplated. In other embodiments, the incremental z₂ adjustment is within the range of about 10 μm to about 100 μm. The particular amount of the increase or decrease does not need to be known in advance. In the system 10, the propagation distance z₁ is such that it allows for spatial coherence to develop at the plane of the object(s) 12, and light scattered by the object(s) 12 interferes with background light to form a lens-free in-line hologram on the image sensor 16.

Still referring to FIG. 1A, the system 10 includes a computer 30 such as a laptop, desktop, tablet, mobile communication device, personal digital assistant (PDA) or the like that is operatively connected to the system 10 such that lower resolution images (e.g., lower resolution or raw image frames) are transferred from the image sensor 16 to the computer 30 for data acquisition and image processing. The computer 30 includes one or more processors 32 that, as described herein in more detail, runs or executes software that takes multiple, sub-pixel (low resolution) images taken at different scan positions (e.g., x and y positions as seen in inset of FIG. 1A) and creates a single, high resolution projection hologram image of the objects 12. The software also digitally reconstructs complex projection images of the objects 12 through an iterative phase recovery process that rapidly merges all the captured holographic information to recover lost optical phase of each lens-free hologram. The phase of each lens-free hologram is recovered and one of the pixel super-resolved holograms is back propagated to the object plane to create phase and amplitude images of the objects 12. The reconstructed images can be displayed to the user on, for example, a display 34 or the like. The user may, for example, interface with the computer 30 via an input device 36 such as a keyboard or mouse to select different imaging planes.

FIG. 1A illustrates that in order to generate super-resolved images, a plurality of different lower resolution images are taken as the illumination source 20 is moved in small increments generally in the x and y directions. The x and y directions are generally in a plane parallel with the surface of the image sensor 16. Alternatively, the illumination source 20 may be moved along a surface that may be three-dimensional (e.g., a sphere or other 3D surface in the x, y, and z dimensions). Thus, the surface may be planar or three-dimensional. In one aspect of the invention, the illumination source 20 has the ability to move in the x and y directions as indicated by the arrows x and y in the inset of FIG. 1A. Any number of mechanical actuators may be used including, for example, a stepper motor, moveable stage, piezoelectric element, or solenoid. FIG. 1A illustrates a moveable stage 40 that is able to move the illumination source 20 in small displacements in both the x and y directions. Preferably, the moveable stage 40 can move in sub-micron increments thereby permitting images to be taken of the objects 12 at slight x and y displacements. The moveable stage 40 may be controlled in an automated (or even manual) manner by the computer 30 or a separate dedicated controller. In one alternative embodiment, the moveable stage 40 may move in three dimensions (x, y, and z or angled relative to image sensor 16), thereby permitting images to be taken of objects 12 at slight x, y, and z angled displacements.

In another alternative embodiment, rather than move the illumination source 20 in the x and y directions, a system may use a plurality of spaced apart illumination sources that can be selectively actuated to achieve the same result without having to physically move the illumination source 20 or image sensor 16. In this manner, the illumination source 20 is able to make relatively small displacement jogs (e.g., less than about 1 μm). The small discrete shifts parallel to the image sensor 16 are used to generate a single, high resolution image (e.g., pixel super-resolution). Details of such a fiber optic based device may be found in Bishara et al., “Holographic pixel super-resolution in portable lensless on-chip microscopy using a fiber-optic array,” Lab Chip 11, 1276 (2011), which is incorporated by reference herein.

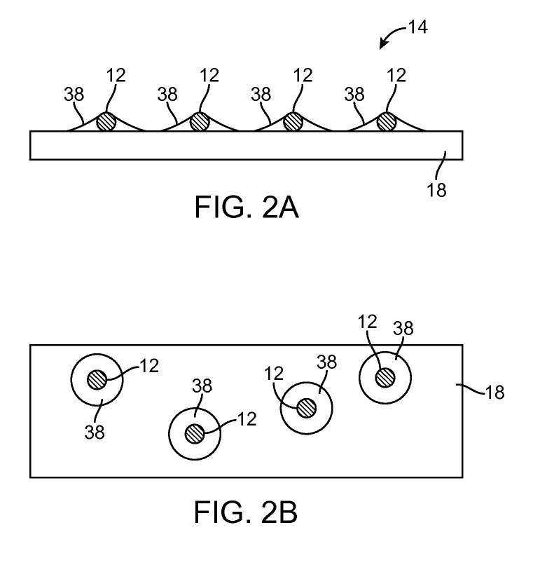

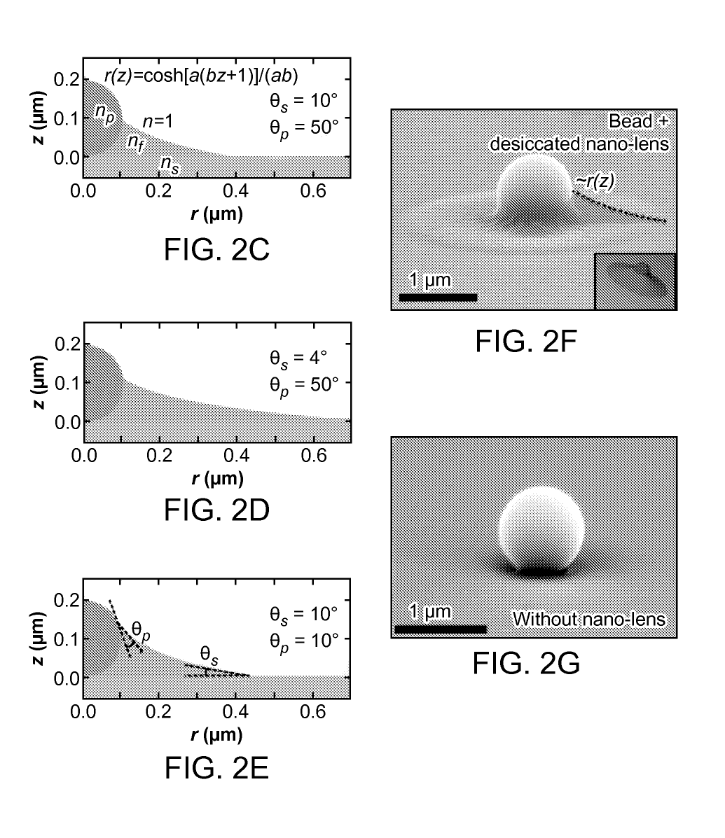

FIG. 2A illustrates a side view of a substrate 18 used to hold the sample 14 containing a plurality of objects 12. A corresponding plan view of the same substrate 18 is seen in FIG. 2B. Both FIGS. 2A and 2B illustrates views after self-assembled lenses 38 have been formed around each object 12. Each self-assembled lens 38 is formed from a liquid and as seen in FIGS. 2A and 2B surrounds each object 12. The self-assembled lens 38 forms a catenoid-shaped surface around the object 12. A catenoid shape is a surface in three-dimensional space arising by rotating a catenary curve about its directrix. While the three dimensional shape of the lenses 38 has been described as a catenoid it should be understood that various other shapes or variations may be formed. FIGS. 2C, 2D, and 2E illustrate different shapes of self-assembled lenses 38 for different substrate (θₛ) and particle (θₚ) contact angles. The image illustrated in FIG. 2F illustrates an SEM image of a bead with a self-assembled lens 38. Shown in the inset of FIG. 2F is the three-dimensional model used in the optical simulations used to validate the imaging method. FIG. 2G illustrates an SEM image of a bead without a self-assembled lens 38.

Referring back to FIG. 2B, each lens 38 surrounding the objects 12 are separated from adjacent lenses 38 by an area or region that is free from fluid or other objects. In one aspect, the substrate 18 may be in the form of glass although other optically transparent substrates may be used. The size of the substrate 18 is chosen based on the active imaging area of the image sensor 16. The substrate 18 includes a highly hydrophilic surface on which the sample 14 is deposited. For example, if the substrate 18 is glass it may be treated with a plasma generator to create a highly hydrophilic surface.

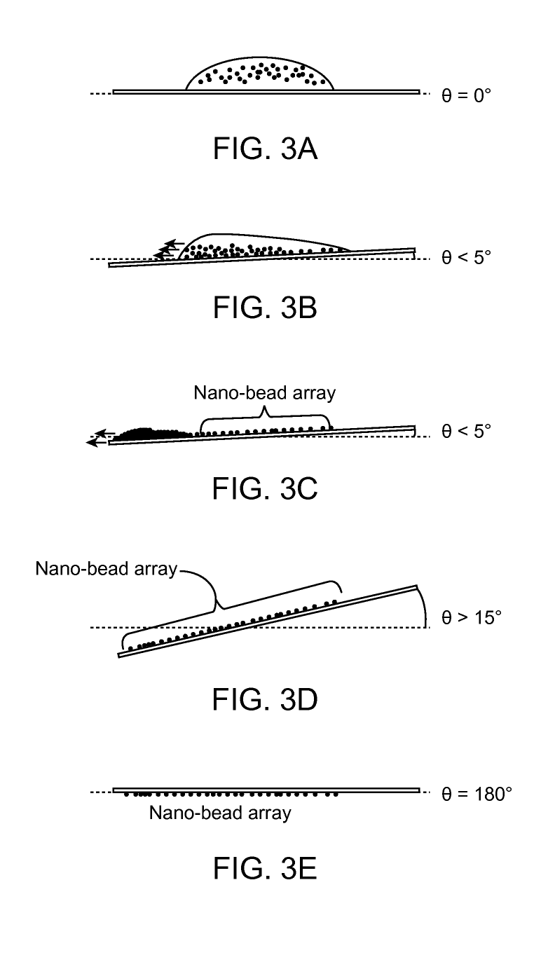

FIGS. 3A-3E illustrate a process of preparing a sample in which objects 12 are disposed on a substrate 18 with each object 12 having a self-assembled lens 38. In this embodiment, the substrate 18 which may be glass is subject to plasma treatment using, for example, a portable plasma generator for approximately five (5) minutes. Plasma treatment of the glass substrate 18 prepares a hydrophilic surface. The sample 14 that is to be imaged may sometimes require dilution in order to create the desired population density of objects 12 disposed on the substrate 18. As an example, the sample 14 may be diluted in polymer-based buffer solution (e.g., 0.1 M Tris-HCl with 10% polyethylene glycol (PEG) 600 buffer—Sigma Aldrich). The buffer solution helps to prevent objects 12 from aggregation while also acting as a spatial mask that relatively enhances the lens-free diffraction signature of the embedded objects 12. The buffer is biocompatible and stable for an extended period of time (e.g., over an hour) without significant evaporative loss.

Initially, as seen in FIG. 3A, a small droplet (e.g., 5-10 μL microliters) of the sample 14 is transferred to the central region of the substrate 18. The substrate 18, with the sample 14 disposed thereon, is then held substantially flat for several minutes (e.g., three minutes) to allow partial sedimentation of objects 12. After the settling process, the substrate 18 is then tilted (relative to horizontal) at a first angle so that gravity slowly drives the droplet of sample 14 toward the edge of the substrate 18. This process is illustrated in FIGS. 3B and 3C. Generally, the first angle may be between about 1° to about 10° although other angles may be employed. The droplet of sample 14 moves at relatively slow rate or less than about 1 mm/second. Referring now to FIG. 3D, once the droplet of sample 14 reaches the edge of the substrate 18, the excess fluid is removed by tilting the sample at a second angle that is greater than the first angle. Generally, the second angle may be between about 15° to about 30° although other angles may be employed. Following this last step, the substrate 18 is then flipped 180° as illustrated in FIG. 3E.

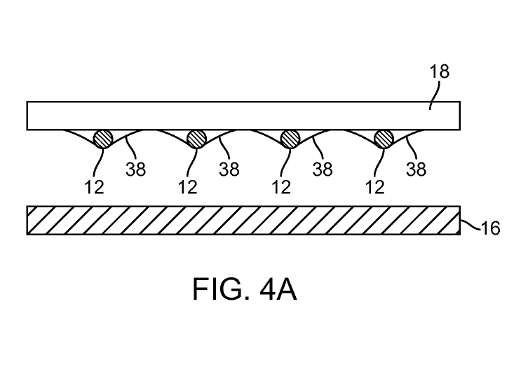

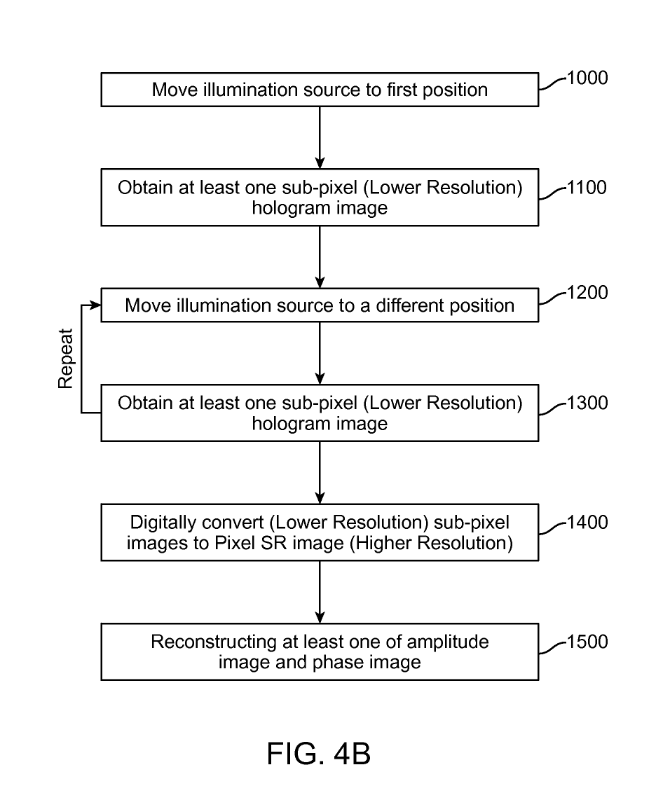

Once the substrate 18 has been flipped 180° the substrate may be placed onto or adjacent to the image sensor 16 as seen in FIG. 4A. At this point, the remaining fluid volume in each lens 38 is so small that its three-dimensional geometry is mainly determined by surface tension, making the effect of the gravity negligible, i.e., this final 180° rotation step does not affect the lens geometry. The entire sample preparation process takes less than ten (10) minutes, and is performed without the use of a cleanroom.

The present method for forming self-assembled lenses 38 is advantageous because it enables imaging of very small objects 12. Liquid film coatings with different compositions and sample preparation methods have been previously used in conjunction with optical microscopy, however these earlier methods employed thick (e.g., ˜1 μm) and continuous films, rather than isolated lenses 38 that self-assembled around individual objects 12, as a result of which they could not detect single nanometer-sized particles that are smaller than 0.5-1 μm in width or diameter.

FIG. 4B illustrates a top-level flowchart of how the system 10 obtains higher resolution pixel Super Resolution (Pixel SR) images of objects 12 within a sample 14 and then reconstructs at least one of an amplitude image and a phase image. After samples 14 are loaded into (or on) the substrate 18, the illumination source 20 is moved to a first x, y position as seen in operation 1000. The illumination source 10 illuminates the sample 14 and a sub-pixel (LR) hologram image is obtained as seen in operation 1100. Next, as seen in operation 1200, the illumination source 10 is moved to another x, y position. At this different position, the illumination source 10 illuminates the sample 14 and a sub-pixel (LR) hologram image is obtained as seen in operation 1300. The illumination source 20 may then be moved again (as shown by Repeat arrow) to another x, y position where a sub-pixel (LR) hologram is obtained. This process may repeat itself any number of times so that images are obtained at a number of different x, y positions. Generally, movement of the illumination source 10 is done in repeated, incremental movements in the range of about 0.001 mm to about 500 mm.

In operation 1400, the sub-pixel (LR) images at each x, y position are digitally converted to a single, higher resolution Pixel SR image (higher resolution), using a pixel super-resolution technique, the details of which are disclosed in Bishara et al., Lens-free on-chip microscopy over a wide field-of-view using pixel super-resolution, Optics Express 18:11181-11191 (2010), which is incorporated by reference. First, the shifts between these holograms are estimated with a local-gradient based iterative algorithm. Once the shifts are estimated, a high resolution grid is iteratively calculated, which is compatible with all the measured shifted holograms. In these iterations, the cost function to minimize is chosen as the mean square error between the down-sampled versions of the high-resolution hologram and the corresponding sub-pixel shifted raw holograms. The conversion of the LR images to the Pixel SR image is preferably done digitally through one or more processors. For example, processor 32 of FIG. 1A may be used in this digital conversion process. Software that is stored in an associated storage device contains the instructions for computing the Pixel SR image from the LR images. As seen in operation 1500, at least one of an amplitude image and a phase image is reconstructed from the Pixel SR image. To obtain a phase or amplitude image, a desired image plane is selected and back propagated to the object plane. This enables the one to extract the desired amplitude and/or phase reconstructed images of the objects 12 within the sample 14.

In one alternative embodiment, there is no need to convert multiple lower-resolution images into a Pixel SR image. For example, a single, lower resolution hologram may be sufficient to see individual objects 12. In this alternative embodiment, there is no need to move the illumination source to different positions to obtain multiple lower resolution images (i.e., operations 1200, 1300, and 1400 may be omitted).

The use of the self-assembled lenses 38 significantly improves the imaging performance of the system 10. Signal-to-noise ratio (SNR) is improved and therefore the resolution quality of the images is increased. This improved resolution, when combined with obtaining higher resolution Pixel SR images enables lens-free imaging of objects 12 having sizes smaller than 100 nm.

### Experimental

For imaging experiments a quasi-monochromatic light source (480 nm center wavelength; ˜3 nm bandwidth) was coupled to a multi-mode fiber (core size: 0.1 mm) The end of the fiber was located at a distance z₁=8-12 cm above the image sensor. For further miniaturization and field portability, the light source can also be a single light-emitting diode (LED) or an array of LEDs, enabling a compact microscopy architecture. The samples to be imaged were located typically at z₂<1-2 mm from the active surface of the CMOS imaging sensor. Image acquisition was performed using only the green colored pixels of a 16 megapixel (RGB) CMOS chip (from Sony Corporation) or using a monochrome 39 megapixel CCD chip (from Kodak).

Because of the small object-to-sensor distance (i.e., z₂˜300 μm), the spatial coherence, temporal coherence, and illumination alignment requirements in this microscopy set-up are all relaxed, significantly reducing the speckle and multiple reflection noise artifacts over the entire active area of the CMOS array. On the other hand, because of unit magnification and the finite CMOS pixel size (1.12 μm), individual lens-free holograms are under-sampled, partially limiting the achievable spatial resolution and SNR. To mitigate this limitation, a pixel-super resolution technique is employed that digitally merges multiple holographic images that are shifted with respect to each other by sub-pixel pitch distances into a single high resolution image. Discrete source shifts of approximately 0.1 mm translate to sub-micron hologram shifts at the detector plane due to the large z₁ to z₂ ratio of >200. These pixel super-resolved high resolution holograms are then used to digitally reconstruct the complex object field at the sample plane using iterative phase retrieval techniques to eliminate twin image noise and obtain higher SNR microscopic images of the sample.

Samples were received as concentrated nano-particle solutions (polystyrene beads from Corpuscular Inc.), as well as cultured influenza A (H1N1) viral particles and adenoviruses that were fixed using 1.5% formaldehyde. The virus specimens with an initial density of 100,000/μL are centrifuged at ˜25,000 g, and supernatant is separated and filtered using a 0.2 μm pore size syringe filter to remove larger contamination and clusters. Small volumes of concentrated nano-bead or virus solutions are then diluted at room temperature using 0.1 M Tris-HCl with 10% PEG 600 buffer (Sigma Aldrich), and are sonicated for ˜2 min so that the final concentration is >20,000/μL. The hydrophilic substrate was prepared by cleaning a 22 mm×22 mm glass coverslip (Fisher Scientific, USA) with isopropanol and distilled water, and then by plasma-treating it using a portable and light-weight plasma generator (Electro-technic Products, Inc., Model #: BD-10AS) for approximately 5 min.

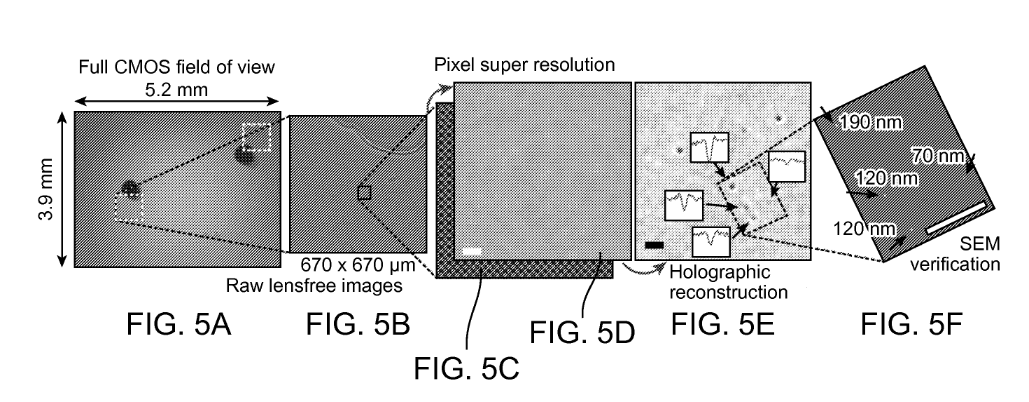

FIGS. 5A-5F illustrate images corresponding to the operations of FIG. 4B. FIG. 5A illustrates the raw, full field-of-view obtained from a CMOS chip used to image different sized beads contained within self-assembled lenses on a hydrophilic glass substrate. The large black marks in FIG. 5A facilitate registration with SEM images. FIG. 5B illustrates the expanded region of FIG. 5A. FIG. 5C illustrates raw lens-free Bayer-pattern RGB images. These are converted into high-resolution monochrome holograms via pixel super-resolution as illustrated in FIGS. 5D and 5E. FIG. 5E illustrates individual beads with their associated cross-sections. FIG. 5F illustrates the SEM image of the expanded region of FIG. 5E. The different beads are labelled with their respective sizes. It is clear that the lens-free imaging method is able to image objects having a size that is less than 100 nm. Scale bars are 5 μm.

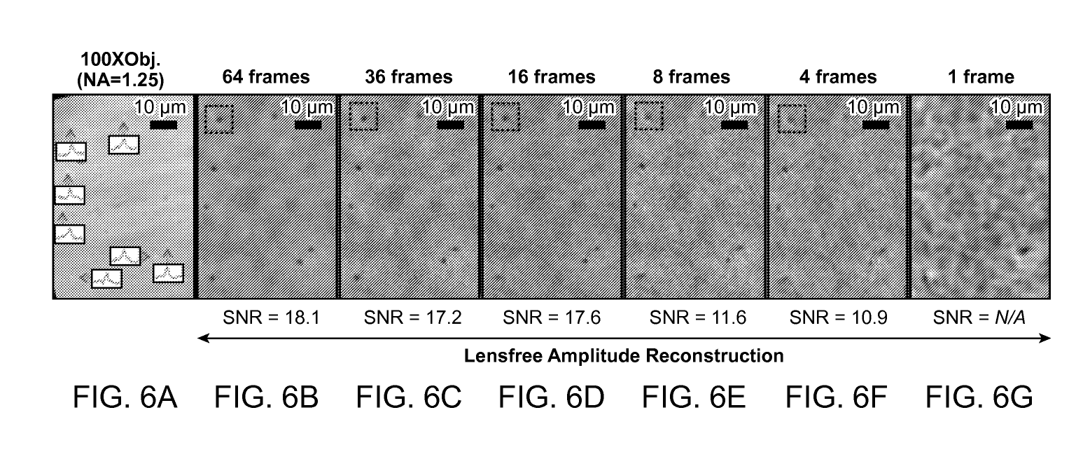

The effect of the number of holographic frames used for pixel super-resolution on the contrast and SNR of the nano-particle images is characterized in the lower set of panels in FIGS. 6A-6G. In these experiments, various lens-free holographic images of 95 nm sized beads were reconstructed from pixel super-resolved images synthesized using e.g., 1, 4, 8, 16, 36 and 64 sub-pixel shifted holographic frames, respectively. Reconstruction of a single lens-free frame (FIG. 6G) did not provide any satisfactory result for detection of these 95 nm particles, whereas increasing the number of holographic frames employed in the pixel super-resolution algorithm significantly enhanced the contrast and the SNR of individual nano-particles. FIG. 6A shows a corresponding image obtained of 95 nm sized particles using a bright-field, oil-immersion 100× objective-lens (NA=1.25). Improvement in contrast and SNR of 95 nm particles using pixel super-resolution is demonstrated. With >16 sub-pixel-shifted lens-free frames (FIGS. 6B, 6C, 6D), individual nano-particles are detectable. SNR values correspond to the 95 nm particle within the square located in the upper left corner.

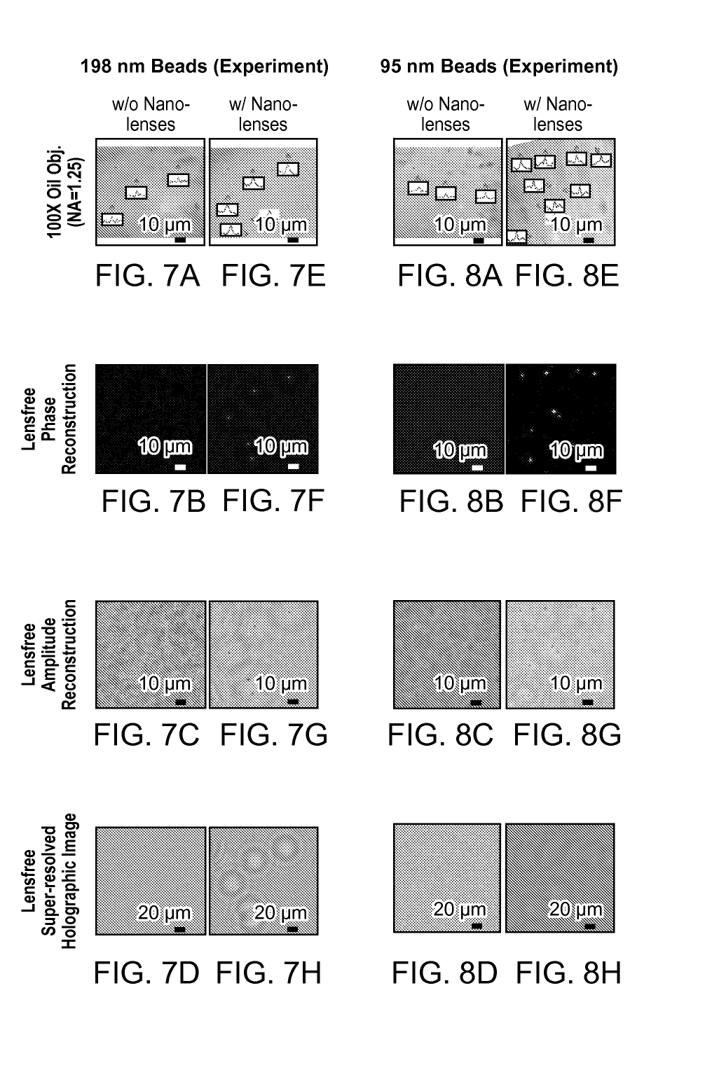

Imaging experiments were also conducted on 198 nm and 95 nm diameter styrene beads that were prepared with and without self-assembled lenses. Without the self-assembled lenses, neither 198 nm nor 95 nm diameter polystyrene beads provide a signal above the background noise level in the lens-free holographic microscopy setup. However with the formation of the above discussed lenses, these nanometer-sized particles become clearly visible in both phase and amplitude reconstructions as illustrated in FIGS. 7F, 7G, 8F, 8G. Both with and without the liquid lenses, the presence of the nanometer-sized particles on the substrate is confirmed in these experiments using oil-immersion bright-field microscopy, although the contrast and SNR of these images are rather low despite the use of a high power objective-lens (100×, NA=1.25). On the other hand, using lens-free on-chip microscopy, the contrast of the same nano-particles are significantly improved after the formation of the nano-lenses, which act as spatial phase masks enhancing the diffraction holograms of individual nano-particles.

Specifically, FIG. 7A illustrates a 100× oil-immersions objective lens image (NA=1.25) of 198 nm beads. FIG. 7B illustrates the lens-free phase reconstruction image. FIG. 7C illustrates the lens-free amplitude reconstruction image. FIG. 7D illustrates the lens-free super-resolved holographic image. The 198 nm beads imaged in FIGS. 7A-7D were prepared without self-assembled lenses. FIGS. 7E-7H illustrate the same corresponding images of the same sized beads (i.e., 198 nm beads) prepared with self-assembled lenses.

FIG. 8A illustrates a 100× oil-immersions objective lens image (NA=1.25) of 95 nm beads. FIG. 8B illustrates the lens-free phase reconstruction image. FIG. 8C illustrates the lens-free amplitude reconstruction image. FIG. 8D illustrates the lens-free super-resolved holographic image. The 95 nm beads imaged in FIGS. 8A-8D were prepared without self-assembled lenses. FIGS. 8E-8H illustrate the same corresponding images of the same sized beads (i.e., 95 nm beads) prepared with self-assembled lenses. Using lens-free microscopy, neither 198 nm nor 95 nm beads can be detected using regular smears ‘without’ liquid self-assembled lenses. In contrast, the formation of liquid self-assembled lenses enables holographic detection of both bead sizes via amplitude and phase images.

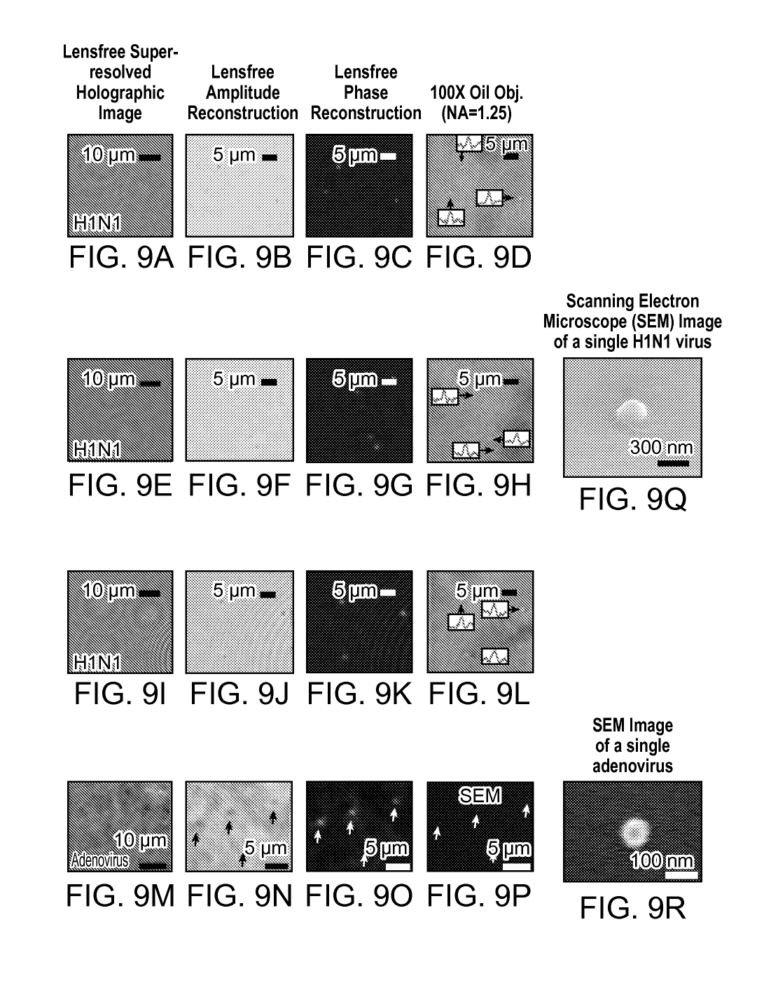

FIGS. 9A-9Q illustrate how the platform may be used to image and detect single virus particles (H1N1 virus particles and adenovirus particles). Samples were prepared in accordance with the method of tiling illustrated in FIGS. 3A-3E. For example, nanometer-sized particles (“nano-particles”) such as viruses are suspended in a Tris-HCl buffer solution with 10% polyethylene glycol (molecular weight 600 Da). A small droplet (<10 μL) is deposited on a plasma-cleaned substrate (e.g., glass). The plasma cleaning removes contamination and renders the substrate hydrophilic, which results in very small droplet contact angles (<10°). After being left to sediment for a few minutes, the sample is tilted (for example using the first and second tilting angles as described herein). Excess solution is allowed to slide off the cover glass. In the wake of the droplet, individual nanoparticle-nano-lens complexes remain (as illustrated in FIG. 2B).

Still referring to FIGS. 9A-9Q, different super-resolved holographic regions of interest were digitally cropped from a much larger FOV (20.5 mm²) for these virus samples, and were then digitally reconstructed to yield both lens-free amplitude and phase images of the viral particles. FIGS. 9A, 9E, and 9I illustrate lens-free super-resolved holographic images of H1N1 virus particles. FIG. 9M illustrates a lens-free super-resolved holographic image of adenovirus particles. Holographic fringes for adenoviruses (FIG. 9M) are weak due to the smaller size of the particles (<100 nm). For comparison purposes, bright-field oil immersion images (100×, NA=1.25) are illustrated of corresponding views of H1N1 particles. These are seen in FIGS. 9D, 9H, and 9L. FIG. 9P illustrates a Scanning Electron Microscope (SEM) image of the corresponding field of view of FIG. 9M. SEM is used here because adenovirus particles cannot be observed using bright-filed microscopy.

FIGS. 9B and 9C illustrate, respectively, lens-free amplitude and phase reconstruction images of the holographic image of FIG. 9A. H1N1 particles are visible in both FIGS. 9B and 9C. FIGS. 9F and 9G illustrate, respectively, lens-free amplitude and phase reconstruction images of the holographic image of FIG. 9E. H1N1 particles are visible in both FIGS. 9F and 9G. FIGS. 9J and 9K illustrate, respectively, lens-free amplitude and phase reconstruction images of the holographic image of FIG. 9I. H1N1 particles are visible in both FIGS. 9J and 9K. FIGS. 9N and 9O illustrate, respectively, lens-free amplitude and phase reconstruction images of the holographic image of FIG. 9M. Adenovirus particles are visible in both FIGS. 9N and 9O (see arrows pointing to particles). For the small adenovirus samples, the phase reconstruction (FIG. 9O) performs better than the amplitude reconstruction image (FIG. 9N) as they exhibit greater SNR and contrast. FIG. 9Q illustrates a SEM image of a single H1N1 virus particle surrounded by a liquid desiccated by the SEM sample preparation process. FIG. 9R illustrates a normal-incidence SEM image of a single adenovirus particle.

The contrast enhancement observed in the experiments is also supported by fluid and optical system models. To shed more light on these observations, the shape of the nano-lens meniscus around each nano-particle is modelled using the Young-Laplace equation:

$$Δ p = ρ gh - γ ( \frac{1}{{R}_{1}} + \frac{1}{{R}_{2}} ) , \qquad ( 1 )$$

where Δₚ is the over-pressure within the meniscus, pρ is the fluid density, g is the gravitational acceleration constant, h is the height of the meniscus, γ is the surface tension, and (1/R₁) and (1/R₂) are the curvatures of the meniscus along its two principal directions. The Young-Laplace equation holds in general at length scales greater than a few tens of nanometres; below this scale, additional forces such as dispersion, van der Waals, steric, or electrostatic forces must also be taken into account.

One can non-dimensionalize equation (1) by the characteristic pressure \sqrt{γρg}, which presents the capillary length scale l_{c}=\sqrt{γ/(ρg)}:

$$\frac{Δ p}{\sqrt{γρ g}} = \frac{h}{{𝓁}_{c}} - {𝓁}_{c} ( \frac{1}{{R}_{1}} + \frac{1}{{R}_{2}} ) . \qquad ( 2 )$$

For water, l_{c}≈2 mm, while for aqueous PEG solutions such as ours the surface tension can be a factor of two smaller over a wide range of concentrations with similar density, making the capillary length shorter but still of roughly millimeter length. The overpressure in the film Δₚ is coupled to the volume of the fluid surrounding the nano-particle, and is determined by the formation process of the liquid nano-lenses. As the fluid slowly drains due to the <5° tilt applied during sample preparation, the sparse nano-particles pin the receding contact line until the surface tension of the fluid in contact with a nano-particle can no longer support the hydrostatic pressure of the deformed contact line, at which point the fluidic bridge between the nano-particle and the bulk receding contact line ruptures. The maximum extent of the contact line deformation before rupture is on the order of the nano-particle size. Therefore the overpressure in the film immediately before and after rupture is on the order of ρgRₚ, which makes Δp/\sqrt{γρg} of order Rₚ/l_{c}≈10⁻⁴. Note also that the gravitational term h/l_{c} is of the same order. However, the curvature terms are of order l_{c}/Rₚ≈10⁴. From this scaling analysis, one finds that the low Bond number limit is present where only the curvature terms are significant. It is important to note that this approximation, Δₚ≈0, neglects the rapid rupture process, where the fluid bridge pinches off and additional overpressure may be introduced. However, quantifying this effect requires numerical fluid dynamic simulations; and more importantly, with the Δp≈0 approximation, one finds good agreement to the nano-particle detection experiments.

Under these assumptions, the Young-Laplace equation (1) reduces to finding a surface with zero net curvature. In cylindrical coordinates, this can be written as,

$$0 = \frac{1}{{R}_{1}} + \frac{1}{{R}_{2}} = \frac{{r}^{″}}{{( 1 + {r}^{′2} )}^{\frac{3}{2}}} - \frac{1}{r \sqrt{1 + {r}^{′2}}} , \qquad ( 3 )$$

where r=r(z) is the radial coordinate of the meniscus at an elevation z above the substrate, and primes indicate derivatives with respect to z. The general solution to this nonlinear second-order ordinary differential equation can be written as a hyperbolic cosine:

$$r ( z ) = \frac{1}{ab} cosh [ a ( bz + 1 ) ] . \qquad ( 4 )$$

This last equation is referred to as the “Nano-lens Equation”, which is used to determine the 3D geometry of the self-assembled liquid lens around each nano-particle. In this equation, a and b are constants that are determined by the contact angle at the particle (θₚ), the contact angle at the substrate (θₛ), as well as the particle radius Rₚ, i.e.,

$$\begin{matrix}a = - arcsinh ( cos {θ}_{s} ) , & ( 5 ) \\ b = \frac{1}{{z}_{0}} [ \frac{1}{a} arcsin ( \frac{β ( {z}_{0} ) cos {θ}_{p} - sin {θ}_{p}}{cos {θ}_{p} + β ( {z}_{0} ) sin {θ}_{p}} ) - 1 ] , & ( 6 )\end{matrix}$$

where z₀ is the elevation of the meniscus-particle contact line and β(z₀) is defined as,

$$β ( {z}_{0} ) = \frac{{R}_{p} - {z}_{0}}{\sqrt{{R}_{p}^{2} - {( {R}_{p} - {z}_{0} )}^{2}}} \qquad ( 7 )$$

The elevation z₀ of the contact line can be determined by numerically solving the following transcendental equation derived from the intersection between the spherical particle surface and the meniscus shape, resulting in:

$$( cos {θ}_{p} + β ( {z}_{0} ) sin {θ}_{p} ) [ arcsinh ( \frac{β ( {z}_{0} ) cos {θ}_{p} - sin {θ}_{p}}{cos {θ}_{p} + β ( {z}_{0} ) sin {θ}_{p}} ) - a ] = \frac{{R}_{p}}{2 {R}_{p} - {z}_{0}} . \qquad ( 8 )$$

The particle diameter Rₚ linearly scales both the height and lateral extent of the meniscus, but does ‘not’ affect its shape or aspect ratio. Although both θₛ and θₚ influence all aspects of the meniscus shape, θₛ most significantly affects the radial extent of the meniscus, while θₚ moderately affects its thickness.

Some representative solutions of the nano-lens equation (4) for different contact angles are shown in FIGS. 2C, 2D, and 2E. The measured contact angle of a ˜1 mm radius droplet on a plasma-treated glass coverslip is θₛ=10°, and the measured contact angle on a polystyrene surface is θₚ=50°. These macroscopic contact angles are used as nominal values for the microscopic system in FIG. 2C-2E since one cannot directly measure the contact angles at the small size scale. Small variations in contact angles can affect the aspect ratio of the meniscus, as illustrated in ‘FIGS. 2C and 2D, but do ‘not’ alter its general shape. The scanning electron microscopy (SEM) image shown in FIG. 2F is typical of the nano-lens after it has been desiccated by the vacuum required in SEM sample preparation. Although the original shape of the liquid film has not been preserved due to vacuum, it is clear that the liquid residue from the film only extends a distance on the order of the particle diameter, in good agreement with the model predictions (e.g., see the curve in FIG. 2F).

In order to evaluate the optical effects of each nano-lens on the recorded lens-free holograms of the nano-particles, two numerical models were employed: (1) a finite-difference time-domain (FDTD) simulation followed by Rayleigh-Sommerfeld wave propagation; and (2) a thin-lens model followed by Rayleigh-Sommerfeld wave propagation. In the FDTD model (see FIGS. 2C-2E), a simulation was performed using a particle (nₚ=1.61), the nano-lens (n_{f}=1.35), and the substrate (nₛ=1.52) within a simulation volume of 20×20×5 μm, calculating the amplitude and phase of the transmitted optical field 3 μm beyond the glass-air interface, i.e., no evanescent waves are considered as our detection occurs beyond the near-field. These results are then substituted at the center of a larger (100×100 μm) homogeneous field (i.e., uniform plane wave) that is numerically propagated a distance of 297 μm (i.e., Z₂—3 μm), resulting in a simulated lens-free diffraction hologram. In the thin lens model, however, one ignores 3D scattering and represent the particle and its surrounding nano-lens as a single 2D phase-only object whose phase delay as a function of radial coordinate is the free-space wavenumber k₀ times the line integral of the optical path length in z through the entire depth of the materials at that coordinate. For both of these optical models, the nano-lens equation (4), described above, is used to estimate the 3D geometry of the liquid lens that forms around each nano-particle.

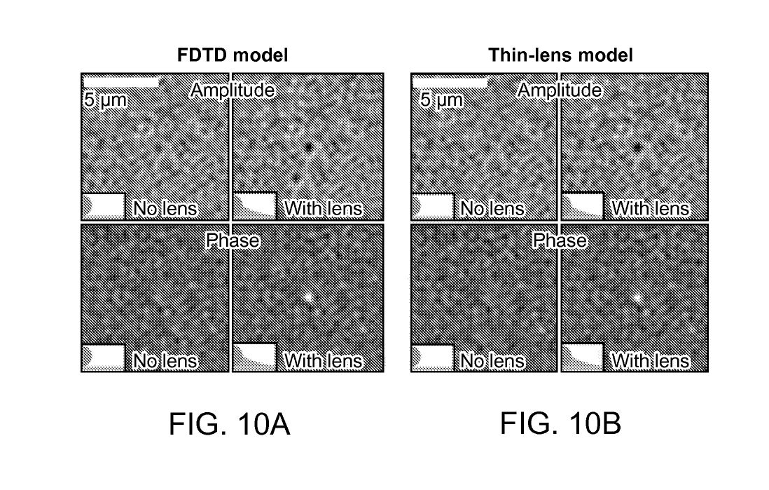

To provide a fair comparison to the experimental results, the numerically generated lens-free holograms are down-sampled to a super-resolved effective pixel size (i.e., 0.28 μm); and then add randomly generated Gaussian noise to each hologram, and quantize the pixel values to 10-bit levels. In FIGS. 10A and 10B, these numerically-generated noisy holograms are used to attempt to reconstruct 95 nm particles with and without nano-lenses. For both the FDTD model (FIG. 10A) and the thin-lens model (FIG. 10B), the nano-lenses significantly improve the image contrast such that the nano-particle can be clearly distinguished from the background noise in both the amplitude and phase reconstructions. Without the liquid nano-lens, however, the same numerical models reveal that the signature of the 95 nm particle is effectively lost within the background noise, also agreeing with our experimental observations.

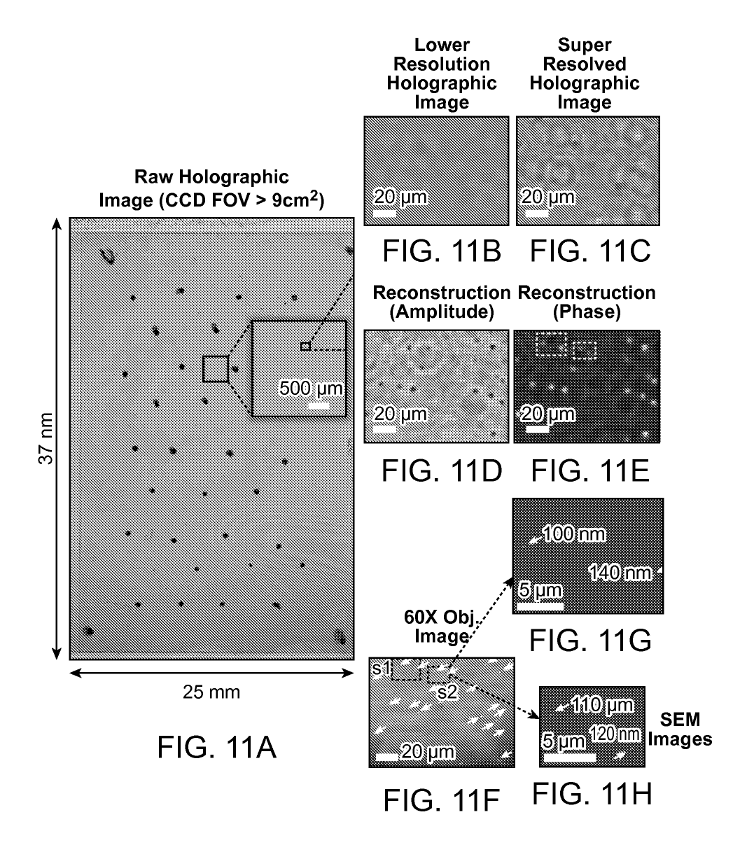

While this state-of-the-art image CMOS sensor provides high resolution imaging capability due to its fine spatial sampling of holographic fringes, the imaging throughput of the platform can be further increased by more than an order of magnitude by moving to large area CCD chips. FIGS. 11A-11H illustrates lens-free nanoparticle imaging results that were generated using a wide-field CCD chip (purchased from Kodak) with an active area of >18 cm² (which is more than 90-fold larger than the active area of the CMOS chip used in other experiments) and a pixel size of 6.8 μm. Only one-half of the active area of this CCD chip was utilized in the lens-free imaging experiments shown here, providing a FOV of >9 cm². FIG. 11A illustrates the raw holographic image with a magnified cropped region A taken from the raw image and shown in inset. FIG. 11B illustrates cropped region B which was taken from the cropped region A of FIG. 11A. FIG. 11C illustrates the super-resolved holographic image of cropped region B. FIG. 11D illustrates the reconstructed amplitude image of the super-resolved holographic image. FIG. 11E illustrates the reconstructed phase image of the super-resolved holographic image. FIG. 11F illustrates a contrast and background-subtracted 60× objective lens-based image of the corresponding region-of-interest. FIG. 11G illustrates a corresponding SEM image of region S1 of FIG. 11F. FIG. 11H illustrates a corresponding SEM image of region S2 of FIG. 11F. Although the larger pixel size (6.8 μm) of the CCD chip decreases the sampling frequency of lens-free holograms, it is nonetheless possible to image individual nano-particles smaller than 150 nm.

While the invention described herein has largely been described as a “lens free” imaging platform, it should be understood that various optical components, including lenses, may be combined or utilized in the systems and methods described herein. For instance, the liquid lenses surrounding particles may be used in conventional lens-based microscopic imaging systems. The nano-lenses can enable conventional lens-based imaging systems to see smaller particles. In another alternative application, the devices described herein may use small lens arrays (e.g., micro-lens arrays) for non-imaging purposes. As one example, a lens array could be used to increase the efficiency of light collection for the sensor array. Such optical components, while not necessary to image the sample and provide useful data and results regarding the same may still be employed and fall within the scope of the invention. While embodiments of the present invention have been shown and described, various modifications may be made without departing from the scope of the present invention. The invention, therefore, should not be limited, except to the following claims, and their equivalents.

1. A method of imaging a sample comprising:
depositing a droplet containing the sample on a substrate, the sample comprising a plurality of particles contained within a fluid;
tilting the substrate to gravitationally drive the droplet to an edge of the substrate while forming a dispersed monolayer of particles having liquid lenses surrounding said particles;
obtaining at least one lower resolution image of the particles contained on the substrate, wherein the substrate is interposed between an illumination source and an image sensor; and
reconstructing at least one of an amplitude image and a phase image of the particles contained within the sample.

2. The method of claim 1, wherein a plurality of lower resolution images are obtained, wherein each lower resolution image is obtained at discrete spatial locations and further comprising converting the plurality of lower resolution images of the particles into a high resolution image.

3. The method of claim 1, wherein the particles comprise cells.

4. The method of claim 1, wherein the particles comprise viruses.

5. The method of claim 1, wherein the particles have a diameter less than about 500 nm.

6. The method of claim 1, wherein tilting of the substrate comprises tilting the substrate at a first angle followed by tilting the substrate at a second angle greater than the first angle.

7. The method of claim 6, wherein the first angle is between about 1° to about 10°.

8. The method of claim 6, wherein the first angle is between about 15° to about 30°.

9. The method of claim 1, wherein the droplet is gravitationally driven at an average speed of less than about 1 mm/s.

10. The method of claim 1, wherein the substrate is hydrophilic.

11. The method of claim 1, wherein after depositing the droplet and prior to tilting, maintaining the substrate in a flat orientation for a period of time.

12. The method of claim 1, wherein interposition of the substrate between the illumination source and the image sensor comprises flipping the substrate over to place the particles on an underside of the substrate.

13. A method of imaging a sample contained on a substrate comprising:
forming a dispersed monolayer of particles having liquid lenses surrounding said particles on the substrate by depositing a droplet of the sample onto the substrate and tilting the substrate;
interposing the substrate between an illumination source and an imaging system;
illuminating the particles disposed on the substrate with the illumination source; and
obtaining an image of the particles with the image sensor.

14. The method of claim 13, wherein the particles comprise cells.

15. The method of claim 13, wherein the particles comprise viruses.

16. The method of claim 13, wherein the particles have a diameter less than about 500 nm.

17. (canceled)

18. The method of claim 1, wherein tilting of the substrate comprises tilting the substrate at a first angle followed by tilting the substrate at a second angle greater than the first angle.

19. The method of claim 18, wherein the first angle is between about 1° to about 10°.

20. The method of claim 18, wherein the first angle is between about 15° to about 30°.

21. The method of claim 18, wherein the droplet is gravitationally driven at an average speed of less than about 1 mm/s.

22. The method of claim 18, wherein the substrate is hydrophilic glass.

23. The method of claim 18, wherein after depositing the droplet and prior to tilting, maintaining the substrate in a flat orientation for a period of time.

24. The method of claim 18, wherein interposition of the substrate between the illumination source and the imaging system comprises flipping the substrate over to place the particles on an underside of the substrate.
